(19) United States
(12) Patent Application Publication
(10) Pub. No.: US 2023/0083096 A1
(43) Pub. Date: Mar. 16, 2023

(54) CONTEXT BASED LANGUAGE TRAINING SYSTEM, DEVICE, AND METHOD THEREOF

(71) Applicant: Argot Limited, Hong Kong (CN)

(72) Inventors: RAJIV TREHAN, BANGKOK (TH); Brendan McMahon, Bournemouth (GB)

(21) Appl. No.: 17/991,882

(22) Filed: Nov. 22, 2022

Related U.S. Application Data
(63) Continuation-in-part of application No. 17/329,383, filed on May 25, 2021.
Application No. 17/329,383 is a continuation-in-part of application No. 17/317,047, filed on May 11, 2021.

(51) Int. Cl. G06N 20/00

(52) U.S. Cl. CPC G06N 20/00

(57) ABSTRACT

The disclosure relates to system and method for providing context-based language training. The method includes automatically rendering at least one verbal query in a second language; and iteratively performing: receiving at least one second verbal input from the user in the second language; generating a set of input intent maps associated with the at least one second verbal input; matching each of the set of input intent maps with each of a plurality of pre-stored sets of intent maps; determining a distance of each of the set of input intent maps relative to each of the plurality of pre-stored sets of intent maps; identifying a pre-stored intent map from the plurality of pre-stored sets of intent maps closest to the set of input intent maps; and rendering a verbal output reply to the user.

### CROSS-REFERENCE TO RELATED APPLICATION

This application claims the benefit of and is a continuation-in-part of co-pending U.S. application Ser. No. 17/317,047 filed on Nov. 5, 2021 and U.S. application Ser. No. 17/329,383 filed on May 25, 2021, which are hereby expressly incorporated by reference in its entirety for all purposes.

### TECHNICAL FIELD

This disclosure relates generally to gathering information from verbal inputs received form a user and subsequently processing it, and more particularly to system and method for providing context-based language training using Natural Language Processing (NLP).

### BACKGROUND

In today's technology-driven world, individual users and companies increasingly rely on computing systems to facilitate and provide various types of services and assist in performing day to day activities. Among existing technologies, one of the most appealing technologies is mobile technology. The use of mobile technology for language teaching and learning is rapidly growing to acquire communicative skills in foreign languages and cultures. The mobile assisted language learning allows anyone interested in learning a new language to have convenient access regardless of location or time limitations. Moreover, numerous applications, such as DUOLINGO, HELLO TALK, MEMRISE, BUSUU, BABBEL, etc., have been developed to assist learners in learning new language. However, the growing popularity of these language learning applications raises a crucial question, i.e., “Are existing commercial language learning applications, helpful tools for language learners at different stages of proficiency and in multiple context-based situations?” Since, these applications perform well only upon receiving correct response corresponding to the input from the user, as these applications are capable of capturing intent from the user response based on degree to which the response may be good. Most of the existing language learning application are inadequate for the aforementioned scenarios and requirements, as these applications do not use an approach of understanding requests and intents from an input provided by the user.

In order to provide efficient language learning, it is required to ensure that computing system interacts with the users more naturally and effectively. To this end, Artificial Intelligence (AI) systems and methods and Natural Language Processing (NLP) techniques may be required. Machine Learning (ML) is one of the top approaches for deciphering user input's requests and intents. In the ML approach, a neural network may be trained using a dataset labelled and tagged with intents for performing intent classification. The trained neural network offers an excellent connection between user input and intents and may be relied on to have sufficient training instances. However, the existing ML approaches fail when the user input is poorly structured such that it deviates from training datasets. Thus, the ML approach may require maintaining large training sets of well-tagged data for each supported language. This may lead to these approaches being expensive, time consuming, and suffering from quality and bias related issues.

Further, many of these existing language learning applications use NLP techniques to parse text, perform part-of-speech tagging on the parsed text, identify languages associated with the text and identify intent, purpose, request from the parsed text. Further, the NLP techniques may translate an input (for example, voice input or text input) provided in one language to another language. Additionally, the NLP techniques may be used to carry out Text-to-Speech (TTS) or Speech-to-Text (STT) conversions. Moreover, utilizing the NLP techniques to decipher the user intent from the user input is difficult because Speech-to-Text (STT) processing systems may misinterpret specific words and phrases. As a result of such inconsistencies and issues, it becomes really difficult to train a neural networks using the input received from the NLP technique. Thus, this makes deciphering the user intent using the NLP technique difficult. Further, the existing NLP techniques do not perform well for poorly written or structured text because there is a lack of representative training sets for such texts and because the text fragments produced by classical language processing, which divides poorly written texts into smaller pieces, do not adhere to the expected structures, examples, and rules.

Apart from ML based approaches, a natural language input may be processed using a statistical approach and a grammatical approach. Both of these approaches have various limitations. The statistical approach requires large example data sets that are representative of a statistical match that involves matching a text to a known text, a statistical determination of closeness which may be language dependent. The grammatical approach may require using well-defined and processable grammars for each language being considered as per the user input. These grammars may then be required to be mapped to an understanding of user intents in various languages. As the grammar for each of the language differs widely, this may require a parallel grammar-based NLP mechanism to be managed for each language.

Each of above discussed prevalent approaches are hard to trace, question, and comprehend as to how the intent from the user input is determined, how grammar may be adjusted and customized, how training data may be re-tagged to resolve boundary cases, over fit cases and under fit cases. Typically, these approaches identify intents and matches based on correctly constructed fragments and texts. Analysis tends to be either based on machine learning using large sample sets of fragments, which are then mapped to intents, or by using more classical processing in which structure of a sentence is decomposed and analyzed to determine intent, nouns, location, and time. These approaches are efficient when access to large training data samples is appropriately tagged with intents and the large training data samples are available in multiple languages.

Though these above-mentioned techniques may work adequately for properly structured words, fragments, and sentences, however, these NLP models do not work well for poorly structured and poorly worded inputs, responses, and texts, as representative training sets of poor inputs, responses, and texts are limited and classical language processing that breaks down text as text fragments do not provide structures for these poorly worded and structured inputs, responses, and texts. In addition, in cases when choice of words is incorrect, and varying dialects having different grammatical structures or words are used, determination of the user's intent is difficult as comparative data is based on correct training data and correct grammar.

Further, use of the available NLP models for understanding the user intent is challenging as STT processing mechanisms may incorrectly understand certain words and phrases thereby making understanding of the user intent using the NLP model challenging. For example, non-native level speakers often make errors in grammar or word usage during pronunciation making it difficult for the user intent to be understood by data based on correct training data and correct grammar. In addition, machine translations often provide poor translations for the user input. For example, incorrect noun translations in context of a domain or subject and incorrect sentence structures would make it difficult for the intent to be understood by machine learning models based on correct training data and parsing of training data based on grammar of correct text. Additionally, for capturing the user intent in various languages, support for trained and tagged data in different languages may be required. Hence, when the user's intent is incorrectly determined by these approaches, it is hard to understand a reason and to determine a way for resolving a mismatch between the user's actual intent and the derived intent. Further, in order to assist user's in learning new language, there is a need of a technique for understanding user's intent correctly even from incorrectly spoken words or user's with varying dialects having different grammatical structures or words.

Therefore, there is a need in the art for improved methods and systems for providing context-based language training to a user by accurately identifying intents, purposes, requests, and sentence parts from a user input.

### SUMMARY

In an embodiment, a method for providing context-based language training is disclosed. In one example, the method may include automatically rendering at least one verbal query in a second language based on a selected context dimension. The selected context dimension is selected from a plurality of context dimensions created for learning the second language. The method may further include iteratively receiving at least one second verbal input from the user in the second language in response to the rendered at least one verbal query. The received at least one second verbal input may include a plurality of attributes. The method may further include iteratively generating a set of input intent maps associated with the at least one second verbal input based on a first subset of words extracted from the at least one second verbal input and the plurality of attributes. Generating the set of input intent maps may comprise processing the first subset of words through at least one of a plurality of intent map transforming algorithms. The set of input intent maps may be one of a set of partial input intent maps and a set of complete input intent maps. The method may use an NLP model for generating the set of input intent maps. The method may further include iteratively matching each of the set of input intent maps with each of a plurality of pre-stored sets of intent maps. Each of the plurality of pre-stored sets of intent maps may be generated from a single predefined training input and is mapped to a predefined intent and a predetermined response. The single predefined training input may include a predefined verbal input. The method may further include iteratively determining a distance of each of the set of input intent maps relative to each of the plurality of pre-stored sets of intent maps. The method may further include iteratively identifying a pre-stored intent map from the plurality of pre-stored sets of intent maps closest to the set of input intent maps. The method may further include iteratively rendering a verbal output reply to the user via the NLP model. The initial verbal output reply may correspond to the predetermined response mapped to the pre-stored sets of intent maps.

In another embodiment, a system for providing context-based language training is disclosed. In one example, the system may include a processor, and a memory communicatively coupled to the processor. The memory comprises processor instructions, which when executed by the processor causes the processor to automatically render at least one verbal query in a second language based on a selected context dimension. The selected context dimension is selected from a plurality of context dimensions created for learning the second language. The processor instructions may further cause the processor to iteratively receive at least one second verbal input from the user in the second language in response to the rendered at least one verbal query. The received at least one second verbal input may include a plurality of attributes. The processor instructions may further cause the processor to iteratively generate a set of input intent maps associated with the at least one second verbal input based on a first subset of words extracted from the at least one second verbal input and the plurality of attributes. Generating the set of input intent maps may comprise processing the first subset of words through at least one of a plurality of intent map transforming algorithms. The set of input intent maps may be one of a set of partial input intent maps and a set of complete input intent maps. The processor may further cause the processor to use an NLP model for generating the set of input intent maps. The processor instructions may further cause the processor to iteratively match each of the set of input intent maps with each of a plurality of pre-stored sets of intent maps. Each of the plurality of pre-stored sets of intent maps may be generated from a single predefined training input and is mapped to a predefined intent and a predetermined response. The single predefined training input may include a predefined verbal input. The processor instructions may further cause the processor to iteratively determine a distance of each of the set of input intent maps relative to each of the plurality of pre-stored sets of intent maps. The processor instructions may further cause the processor to iteratively identify a pre-stored intent map from the plurality of pre-stored sets of intent maps closest to the set of input intent maps. The processor instructions may further cause the processor to iteratively render a verbal output reply to the user via the NLP model. The initial verbal output reply may correspond to the predetermined response mapped to the pre-stored sets of intent maps.

In yet another embodiment, a non-transitory computer-readable medium storing computer-executable instruction for providing context-based language training is disclosed. The stored instructions, when executed by a processor, may cause the processor to perform operations including automatically rendering at least one verbal query in the second language based on the selected context dimension. The selected context dimension is selected from a plurality of context dimensions created for learning the second language. The operations may further include iteratively receiving at least one second verbal input from the user in the second language in response to the rendered at least one verbal query. The received at least one second verbal input may include a plurality of attributes. The operations may further include iteratively generating a set of input intent maps associated with the at least one second verbal input based on a first subset of words extracted from the at least one second verbal input and the plurality of attributes. Generating the set of input intent maps may comprise processing the first subset of words through at least one of a plurality of intent map transforming algorithms. The set of input intent maps may be one of a set of partial input intent maps and a set of complete input intent maps. The operations may use an NLP model for generating the set of input intent maps. The operations may further include iteratively matching each of the set of input intent maps with each of a plurality of pre-stored sets of intent maps. Each of the plurality of pre-stored sets of intent maps may be generated from a single predefined training input and is mapped to a predefined intent and a predetermined response. The single predefined training input may include a predefined verbal input. The operations may further include iteratively determining a distance of each of the set of input intent maps relative to each of the plurality of pre-stored sets of intent maps. The operations may further include iteratively identifying a pre-stored intent map from the plurality of pre-stored sets of intent maps closest to the set of input intent maps. The operations may further include iteratively rendering a verbal output reply to the user via the NLP model. The initial verbal output reply may correspond to the predetermined response mapped to the pre-stored sets of intent maps.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary system for providing context-based language training, in accordance with some embodiments.

FIG. 2 illustrates a functional block diagram of a user device configured to provide context-based language training, in accordance with some embodiments.

FIG. 3 illustrates an exemplary process for providing context-based language training, in accordance with some embodiments.

FIG. 4 illustrates an exemplary process for generating a set of input intent maps, in accordance with some embodiments.

FIGS. 5A-5F depict various stages of interactive context-based language learning engagement of a user, in accordance with some embodiments.

FIG. 6 depicts an exemplary representation of confidence scores computed for multiple speech to text conversions of a verbal input received from a user, in accordance with an exemplary embodiment.

FIGS. 7A-7C depict an exemplary representation of quizzes attempted by a user via screenshots, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

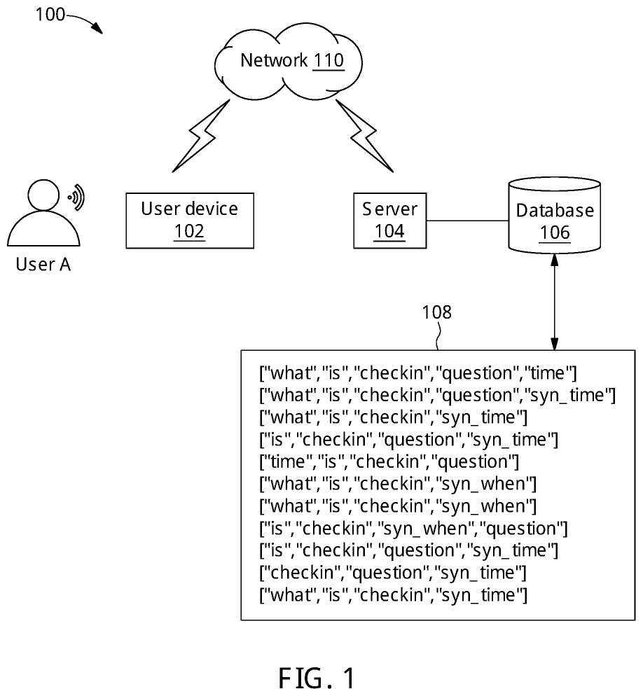

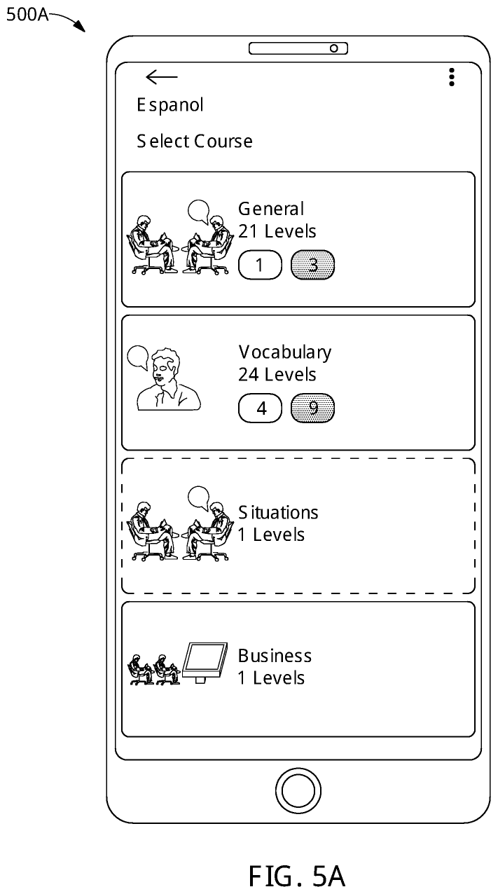

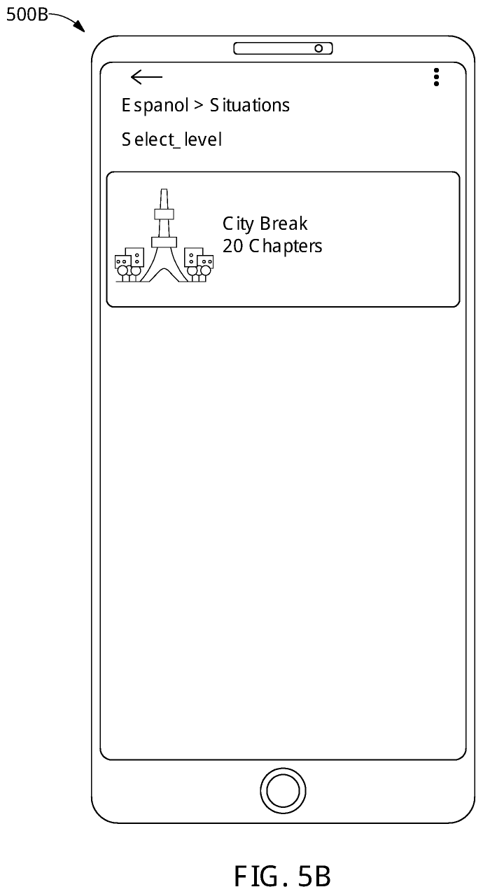

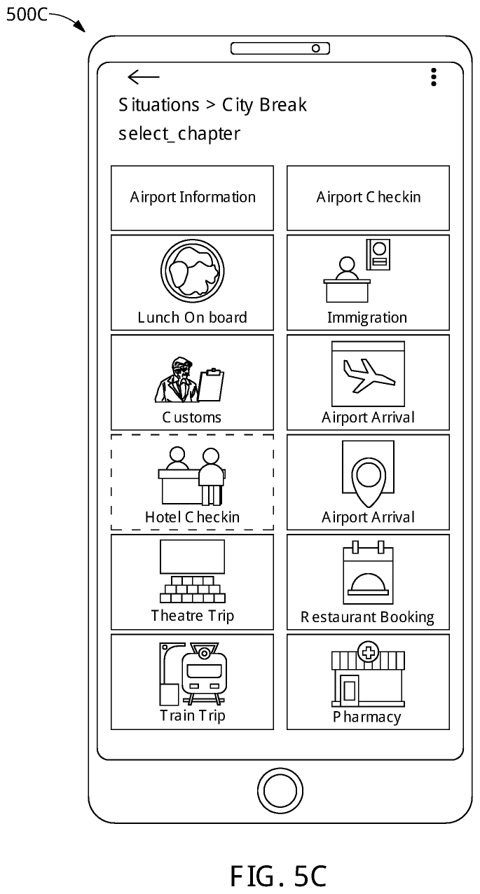

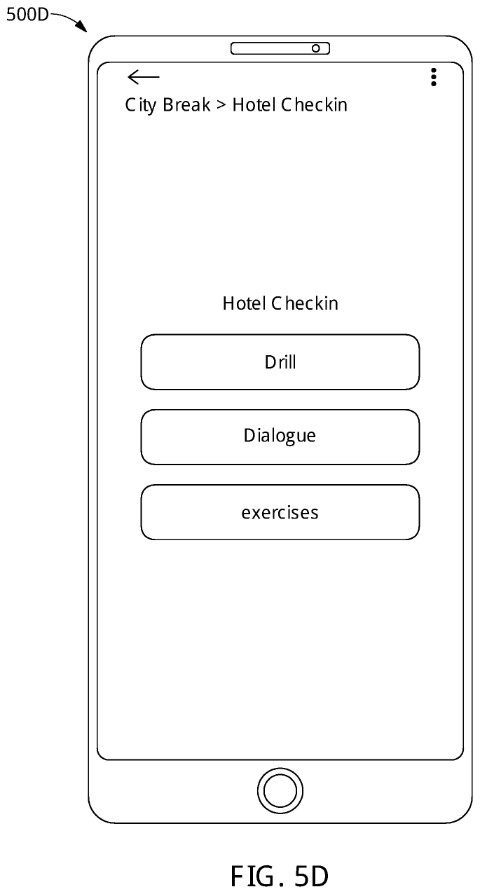

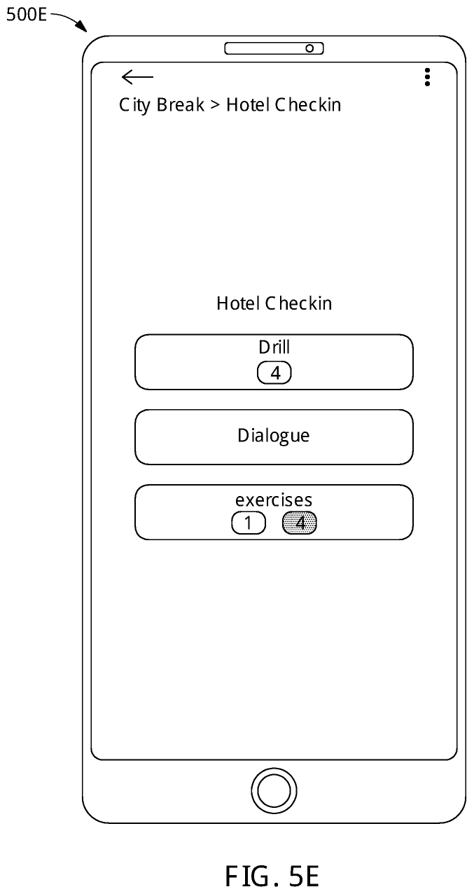

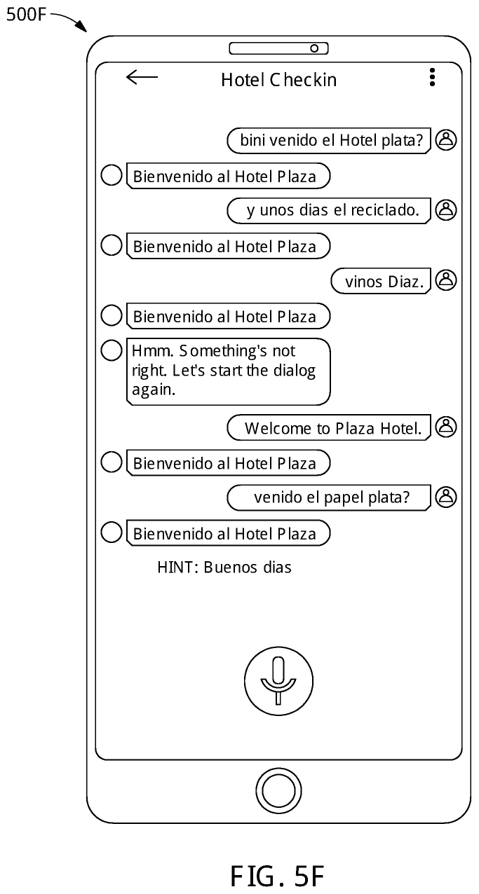

Referring now to FIG. 1, an exemplary system 100 for providing context-based language training is illustrated, in accordance with some embodiments. In present embodiment, initially, a user A may select a course of a particular language (or a second language) that he may be interested in learning. The language, for example, may be Spanish. The user A may select the course from a plurality of course options rendered to the user A via a user device 102. Examples of the user device 102 may include but are not limited to a mobile phone, a laptop, a desktop, or a Personal Digital Assistants (PDA), an application server, and so forth. Each course option may be mapped to a different target language that the user A may want to learn. Further, each course option may also be related to a specific context dimension. Examples of the plurality of course options for each different language may include, but are not limited to, general, vocabulary, situation, and business. Upon selecting the course (e.g., situation), a set of chapters associated with the course may be rendered to the user A via the user device 102. Further, the user A may select a chapter from the rendered set of chapters. The chapter may further include a plurality of practice areas, which may be rendered to the user A via the user device 102, upon selection of the chapter. The user A may then select a practice area associated with the chapter from the plurality of chapters. This has been further explained in detail in reference to FIGS. 5A-5F. Thus, the user selection made for learning the language may corresponds to a context dimension selected from a plurality of context dimensions that may have been created for learning the language (i.e., the second language). The plurality of context dimensions may include, but are not limited to, the plurality of courses, the set of chapters, and the practice area associated with each of the set of chapters, and the like. In other words, each context dimension may have a hierarchical structure, such that, each level further has multiple sub-levels.

In order to interact with the system 100, the user A, via the user device 102 may provide a first verbal input in a first language (for example, English). The first verbal input may include one or more of, but is not limited to a query, a command, a request, an action and the like. Further, the first verbal input may be in form of a sentence, a phrase, a word, a phoneme, or a phoneme in context. In an embodiment, the first verbal input may correspond to the user selection of the second language, the user selection of the course, or the like. In some embodiments, the first verbal input may be provided by the user A in the first language for setting-up the user device 102. Further, the first verbal input may be associated with a context dimension (for example, a chapter, a chapter, a practice area, or a combination thereof) selected from the plurality of context dimensions created for learning the second language (for example, Spanish). It should be noted that, the first verbal input may not be always required for starting an interaction with the user device 102 in order to learn the second language. As will be apparent, the first language and the second language are dissimilar.

The user device 102 may be connected to a communication network 110 (for example, a wired network, a wireless network, the internet, or the like). In one embodiment, the user device 102 may be communicatively coupled to a server 104 via the communication network 110. In some embodiments, the server 104 may receive the first verbal input provided by the user device 102 via the communication network 110. Upon receiving the first verbal input, the server 104 may process the first verbal input and may render a result of processing the first verbal input to the user via the user device 102. Examples of the server 104, may include, but are not limited to a mobile phone, a laptop, a desktop, or a PDA, an application server, and so forth. Based on processing of the first verbal input, the server 104 may automatically render a verbal query in the second language to the user A via the user device 102. The verbal query may be rendered based on the selected context dimension. By way of an example, the user A may have selected “Situation,” “City Breaks”, and “Airport Departure” as the combined context dimension for learning the second language. Accordingly, the verbal query rendered to the user A may be ‘A que Nora es el check-in?’, which means: “What time is check-in?” in English. The user may be required to pronounce the verbal query in the second language, i.e., Spanish. In some configurations, the verbal query may also be presented to the user in textual form, via a display within the user device 102.

In response to rendering the verbal query, the user A may provide a second verbal input in the second language via the user device 102 to the server 104. As required, the second verbal input provided by the user A may be pronunciation of the verbal query in the second language. In an embodiment, the second verbal input may include a plurality of attributes. The plurality of attributes may include at least one of utterance speed, accentuation, voice pitch, vocabulary, pause duration, or grammar.

The server 104 may receive the second verbal input and may use a Natural Language Processing (NLP) model to generate a set of input intent maps associated with the second verbal input. In order to generate the set of input intent maps, initially the NLP model may convert the second verbal input received from the user to a textual input using a Speech-to-Text (STT) mechanism. Further, the textual input may be converted into an intermedia language using machine translation technique. By way of an example, the intermedia language may be English and thus the second verbal input, i.e., ‘A que hora es el check-in?’ may be converted to “What time is check-in?”. Upon converting the second verbal input into the textual input, the NLP model may extract a first subset of words from the textual input. Once the first subset of words is extracted, the NLP model may generate the set of input intent maps based on the first subset of words and the plurality of attributes.

Further, one or more of a morphological level of linguistic processing, a lexical level analysis, a semantic level analysis may be performed on the second verbal input using the NLP model to generate the set of input intent maps. The set of input intent maps may be, for example, a network of words, a network of concepts, a set of related words, fragments of a sentence, a set of sentences of a known domain and the like. In an embodiment, the set of input intent maps may also include one or more forms of verb, desire, question, location, and noun. The set of input intent maps, for example, may be represented or stored as a set of lexeme graphs, a time interval, number of days, a counter, a set of anaphoric references, compound concepts and the like. The generated set of input intent maps may be associated with the second verbal input received from the user A.

Referring back to the above-mentioned example, for the second verbal input “A que hora es el check-in?”, the generated set of input intent maps, for example, may be represented as depicted via the reference numeral (1):

[“what”,“is”,“checkin”,“question”,“time”][“what”,“checkin”,“question”,“syn_time”][“what”,“is”,“checkin”,“syn_time”][“is”,“checkin”,“question”,“syn_time”][“time”,“is”,“checkin”,“question”][“what”,“is”,“checkin”,“syn_when”][“what”,“is”,“checkin”,“syn_when”][“is”,“checkin”,“syn_when”][“question”][“is”,“checkin”,“question”,“syn_time”][“checkin”,“question”,“syn_time”] (1)

It will be apparent that each set of words within each bracket of text depicted via the reference numeral (1) represents a type of intent map. As discussed before, the set of input intent maps may include, but are not limited to a desire, an intent, a question, a location information, a noun, a verb, and similar additional information as determined from the user input. In an embodiment, the generation of the set of input intent maps may include processing of the first subset of words through at least one of a plurality of intent map transforming algorithms. The intent map transforming algorithms may include at least one of a refinement mechanism, a consolidation mechanism, a synonym mechanism, and a reduction mechanism.

Once the set of input intent maps have been generated, each of the set of input intent maps may be matched with each of a plurality of pre-stored sets of intent maps maintained in a database 106. One of the plurality of pre-stored sets of intent maps, for example, may be represented as text depicted via the reference numeral 2:

[“what”,“is”,“checkin”,“question”,“time”][“time”,“is”,“checkin”,“question”][“what”,“is”,“checkin”,“question”,“time”] (2)

A more exhaustive example of pre-stored sets of intent maps is depicted as a set of pre-stored intent maps 108. Each of the plurality of pre-stored sets of intent maps may be generated from a single predefined training input. The single predefined training input may include a predefined verbal input. In continuation of the example given above, the predefined verbal input or the single predefined training input may be “what time is check-in.” The set of pre-stored intent maps 108 may be generated based on the single training input, i.e., “what time is check-in.” As a result, unlike, conventional AI or neural network-based methods, where a huge number of sample queries (in some cases thousands or more) may be required to train the conventional AI or neural network-based methods, the disclosed embodiments require only a single training input. Each of the plurality of pre-stored sets of intent maps may be generated from the single predefined training input based on an iterative and elastic stretching process, such that, each of the plurality of pre-stored sets of intent maps may be gradually manipulated and stretched using at least one of the plurality of intent map transforming algorithms discussed above.

Each of the plurality of pre-stored sets of intent maps is further mapped to a predefined intent and a predetermined response. As may be appreciated, the predetermined response may include, for example, canned text, predefined templates, and AI generated responses based on the user's intent and context. In continuation of the example above, each of the set of pre-stored intent maps 108 may be mapped to the intent “hotel info: check-in” and the predetermined response, which may be a subsequent query in an actual interaction/situation and/or a feedback provided to the user A with respect to his proficiency or deficiency in repeating a given sentence in the second language (Spanish in this case).

In response to matching each of the set of input intent maps with each of the plurality of pre-stored sets of intent maps, a distance of each of the set of input intent maps relative to each of the plurality of pre-stored sets of intent maps may be determined. The distance may correspond to how close each of the set of input intent maps is relative to each of the plurality of pre-stored sets of intent maps. The distance may be computed between vector representations of each of the set of input intent maps and vector representations of each of the plurality of pre-stored sets of intent maps. In this case, the distance, for example, may be a Euclidean distance. In addition, the distance may be based on a generation procedure, and a level of complexity of the set of input intent maps.

Subsequently, a pre-stored intent map closest (i.e., with a least distance) to the set of input intent maps may be identified from the plurality of pre-stored sets of intent maps. Upon identification of the closest pre-stored intent map, a verbal output reply may be rendered to the user A. In an embodiment, the initial verbal output reply may correspond to the predetermined response mapped to the closest pre-stored intent maps. It should be noted that, the first verbal input, the verbal query, the second verbal input, and the initial verbal output reply is in form of a phoneme, a sentence, a phrase, a word, or a phoneme in context. In continuation of the example given above, the pre-stored intent map identified from within the set of pre-stored intent maps 108 as being closest to the set of input intent maps generated for the textual input “what time is check-in?” may be: [“what”, “is”, “checkin”, “question”, “time”].

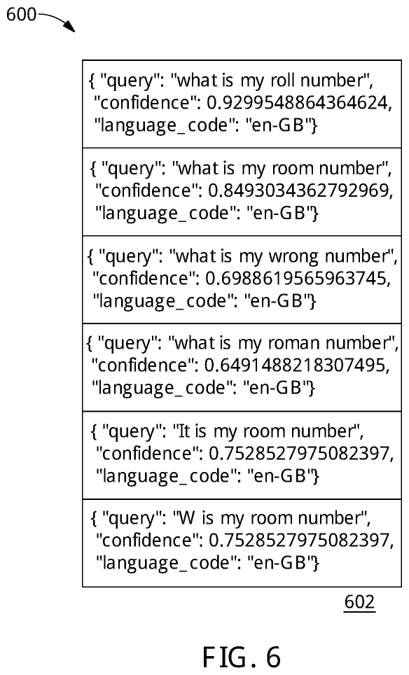

Additionally, as the predetermined response, i.e., “I send you the information now,” is mapped to the pre-stored intent map, i.e., [“what”, “is”, “checkin”, “question”, “time”], hence, this predetermined response may be rendered to the user A. It should be noted that, in one embodiment, the predetermined response may be rendered to the user A in the second language when the user A may have correctly pronounced the verbal query in the second language. For example, the predetermined response may be rendered in the Spanish language as “ahora to envio la informacion.” However, in another embodiment, when the user may not have correctly pronounced the verbal query, then the verbal output reply may be rendered to the user A in the first language (i.e., English) along with feedback with regards to issues or deficiencies in the user A's pronunciation in Spanish. In some embodiments, in addition to the predetermined response and the verbal output reply, at least one graphical element may also be rendered to the user as feedback. This has been explained in detail with reference to FIG. 6.

As may be appreciated, use of at least one of the plurality of intent map transforming algorithms may enable identifying and providing a closest pre-stored intent map while applying a minimum number of transformations to the first subset of words to find a match. This implies that the closest pre-stored intent may be determined by performing a minimum number of transformations involving, for example, stretching and simplifications during an elastic stretching process. In addition, the set of input intent maps and the plurality of pre-stored sets of intent maps may be ordered and maintained such that the search for the closest pre-stored intent map involves performing minimal number of transformations thereby extracting relevant content. Further, based on a context dimension, the set of input intent maps and the plurality of pre-stored sets of intent maps may be ordered and maintained such that the search for the closest pre-stored intent map involves performing minimal number of transformations by the elastic stretching process. In an embodiment, the intent map transforming algorithms may be domain specific and may thus further improve accuracy of match between the set of input intent maps and the plurality of pre-stored sets of intent maps. Additionally, or alternatively, the generated set of input intent maps may be directed to knowledge sources for resolution.

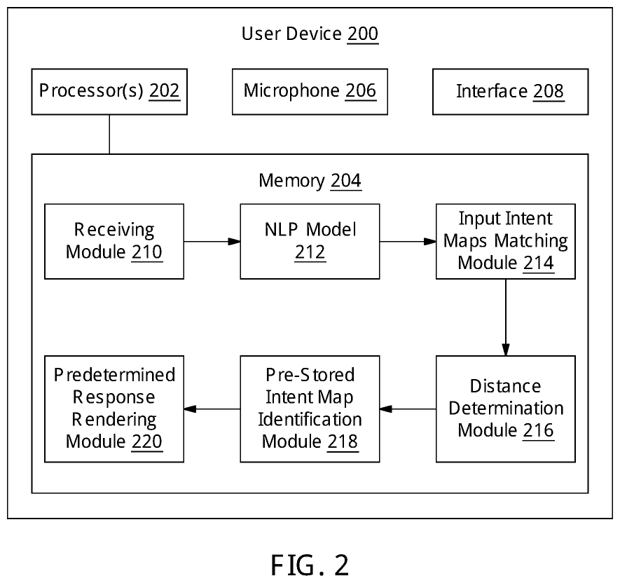

Referring now to FIG. 2, a functional block diagram of a user device 200 configured to provide context-based language training is illustrated, in accordance with some embodiments. The user device 200 may include one or more processors 202, a memory 204, a microphone 206, and one or more interfaces 208. The memory 204 may include a receiving module 210, an NLP model 212, an input intent maps matching module 214, a distance determination module 216, a pre-stored intent map identification module 218, and a predetermined response rendering module 220.

The one or more processors 202 may be implemented as one or more microprocessors, microcomputers, microcontrollers, digital signal processors, central processing units, logic circuitries, and/or any devices that manipulate data based on operational instructions. Among other capabilities, the one or more processors 202 may be configured to fetch and execute processor-executable instructions stored in the memory 204. The memory 204 may store one or more processor-executable instructions or routines, which may be fetched and executed for processing user input using NLP. The memory 204 may include any non-transitory storage device including, for example, volatile memory such as RAM, or non-volatile memory such as EPROM, flash memory, and the like. The one or more interfaces 208 may include a variety of interfaces, for example, interfaces for data input and output devices, referred to as I/O devices, storage devices, and the like.

As discussed above in FIG. 1, initially, the receiving module 210 may be configured to receive a user selection of a particular language that the user may desire to learn. Additionally, post selection of particular language, the receiving module 210 may be configured to receive a user selection of a course within the particular language that the user may be interested in learning. The user may perform the user selection based on a plurality of course options for different languages rendered to the user via the user device 200. Examples of the course options for a given language may include, but are not limited to general, vocabulary, situations, and business. Upon selecting the course (e.g., situation), a set of chapters associated with the course ‘situation’ may be rendered to the user via the user device 200.

Upon rendering the set of chapters, the receiving module 210 may be configured to receive a user selection of a chapter (e.g., hotel check-in) from the rendered set of chapters. Further, receiving module 210 may receive a user selection of a practice area associated with the selected chapter. Examples of the practice area may include, but are not limited to a drill, a dialogue, and an exercise. One or more of the aforementioned user selections may be received as a first verbal input received from the user. The first verbal input may be in a first language (for example, English). The first verbal input may be provided by the user via the microphone 206 of the user device 200. In an embodiment, the first verbal input may be in form of a sentence, a phrase, a word, a phoneme, or a phoneme in context. As discussed above, the first verbal input is associated with a context dimension selected from a plurality of context dimensions created for learning a second language (for example, Spanish). In an embodiment, the selected context dimension may correspond to selection made by user corresponding to the language (the language that the user is interested in learning). In an embodiment, the plurality of context dimensions may include, but is not limited to, the plurality of courses, the set of chapters, the practice area associated with each of the set of chapters, and the like.

The first verbal input may include one or more of, but is not limited to a query, a command, a request, an action, and the like. It should be noted that, the first language and the second language may be dissimilar. Further, upon receiving the first verbal input, the first verbal input may be processed and a result of processing the first verbal input is rendered to the user via the interface 208 of the user device 200. In other words, based on processing of the first verbal input, a verbal query (e.g., a dialogue) may be rendered to the user. The verbal query may be in the second language that the user is interested in learning. Moreover, the verbal query may be rendered based on the selected context dimension. Further, upon rendering the verbal query, the user may provide a second verbal input in the second language for the verbal query via the microphone 206. By way of an example, the second verbal input provided by the user may be pronunciation of the dialogue rendered to the user. The second verbal input may include a plurality of attributes. The plurality of attributes may include at least one of utterance speed, accentuation, voice pitch, vocabulary, pause duration, or grammar.

Upon receiving the second verbal input, the NLP model 212 may generate a set of input intent maps based on a first subset of words extracted from a user input received from a user. The generation of the set of input intent maps may include processing the first subset of words through at least one of a plurality of intent map transforming algorithms. The set of input intent maps may be one of a set of partial input intent maps and a set of complete input intent maps. When the set of input intent maps is the set of partial input intent maps, the set of input intent maps may be generated by iteratively processing the first subset of words through each of the plurality of intent map transforming algorithms. The first subset of words may be iteratively processed in at least a sequential manner or a parallel manner to generate the set of partial input intent maps. In an embodiment, the set of input intent maps may be a node network that includes a plurality of nodes. Further, each of the plurality of nodes may be a vector representation of one of the first subset of words extracted from the user input. By way of an example, the set of input intent maps may be represented or stored as lexeme graphs, a time interval, number of days, a counter, a set of anaphoric references, compound concepts, and the like.

The input intent maps matching module 214 may then match each of the set of input intent maps with each of a plurality of pre-stored sets of intent maps. The matching may be exhaustively performed to find a pre-stored intent map from the plurality of pre-stored sets of intent maps that is closest to the set of input intent maps. Further, the matching may include identification of the pre-stored intent map while traversing a minimum distance amongst the plurality of pre-stored sets of intent maps. Each of the plurality of pre-stored sets of intent maps may be generated from a single predefined training input and may be mapped to a predefined intent and a predetermined response. The single predefined training input may include a predefined verbal input.

In an embodiment, for a dialogue-based learning, matching of the set of input intent maps and subsequent rendering of the predetermined response mapped to the pre-stored sets of intent maps may be performed iteratively. In the dialogue-based learning, each of the plurality of pre-stored sets of intent maps may be generated from a single predetermined training dialogue and may be mapped to a predetermined response template. The predetermined response template may be populated before being rendered based on the set of input intent maps and a current context associated with the user and the dialogue-based learning.

Thereafter, the distance determination module 216 may determine a distance of each of the set of input intent maps relative to each of the plurality of pre-stored sets of intent maps. In other words, upon performing the matching, a determination of a level (i.e., distance traversed for finding a match) of match of each of the set of input intent maps may be done relative to each of the plurality of pre-stored set of intent maps. In case the context dimension is identified and applied, the distance determination module 214 may determine a distance of each of the modified set of input intent maps relative to each of the subset of pre-stored sets of intent maps may be determined. Based on the distance determined, the pre-stored intent map identification module 218 may identify a pre-stored intent map from the plurality of pre-stored sets of intent maps that is closest to the set of input intent maps. In other words, based on the shortest determined distance or the highest determined level of match, the pre-stored intent map may be identified.

Once the pre-stored intent map is identified, the predetermined response rendering module 218 may render a verbal output reply. In an embodiment, the initial verbal output reply may correspond to the predetermined response mapped to the pre-stored intent map. This has been further explained in FIG. 6. In some embodiment, the rendering may include presenting the predetermined response to the user in form of text. The predetermined response may also be presented in form of an intent map. The predetermined response rendering module 218 may be implemented as an assistant having, for example, a male voice or a female voice.

It should be noted that all such aforementioned modules 210-220 may be represented as a single module or a combination of different modules. Further, as will be appreciated by those skilled in the art, each of the modules 210-220 may reside, in whole or in parts, on one device or multiple devices in communication with each other. In some embodiments, each of the modules 210-220 may be implemented as dedicated hardware circuit comprising custom application-specific integrated circuit (ASIC) or gate arrays, off-the-shelf semiconductors such as logic chips, transistors, or other discrete components. Each of the modules 210-220 may also be implemented in a programmable hardware device such as a field programmable gate array (FPGA), programmable array logic, programmable logic device, and so forth. Alternatively, each of the modules 210-220 may be implemented in software for execution by various types of processors (e.g., processor(s) 202). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for identifying common requirements from applications. For example, the exemplary computing device 200 may identify common requirements from applications by the processes discussed herein. In particular, as will be appreciated by those of ordinary skill in the art, control logic and/or automated routines for performing the techniques and steps described herein may be implemented by the computing device 200 either by hardware, software, or combinations of hardware and software. For example, suitable code may be accessed and executed by the one or more processors on the computing device 200 to perform some or all of the techniques described herein. Similarly, ASICs configured to perform some, or all of the processes described herein may be included in the one or more processors on the computing device 200.

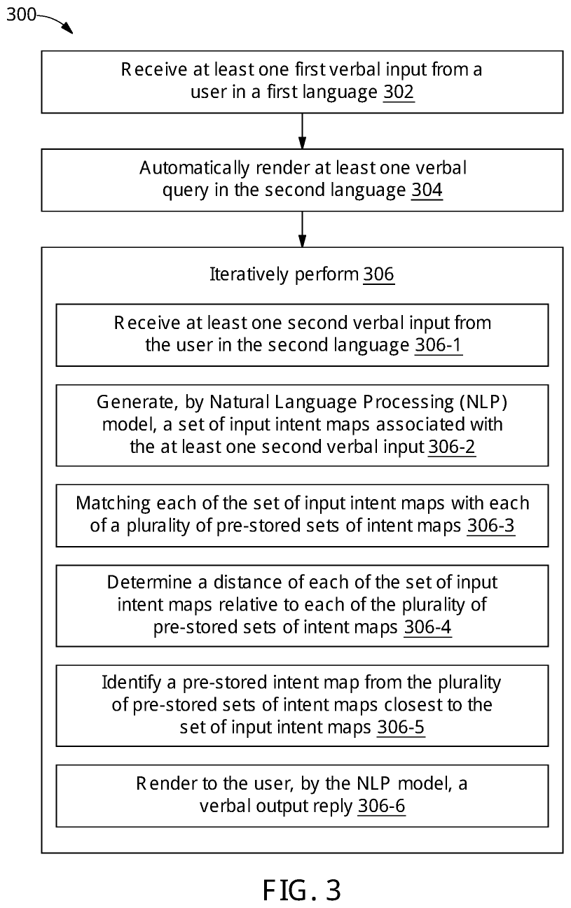

Referring now to FIG. 3, an exemplary process 300 for providing context-based language training via a flowchart is illustrated, in accordance with some embodiments. Initially, at step 302, at least one first verbal input may be received from a user. The at least one first verbal input may be in a first language. Further, the at least one first verbal input may be associated with a context dimension selected from a plurality of context dimensions created for learning a second language. The first language and the second language may be dissimilar. By way of an example, the first language and the second language may be English and Spanish respectively. Upon receiving the at least one first verbal input, at step 304, at least one verbal query may be automatically rendered to the user in the second language based on the selected context dimension. It will be apparent that the step 302 may be optionally performed. Also, the step 302 may be replaced by a non-verbal input via user interface of a user device (for example, the user device 200).

Thereafter, step 306 is iteratively performed, such that, step 306 includes steps 306-1 to 306-6. At step 306-1, at least one second verbal input may be received from the user in the second language in response to the rendered at least one verbal query. The received at least one second verbal input may include a plurality of attributes. In an embodiment, the plurality of attributes may include at least one of utterance speed, accentuation, voice pitch, vocabulary, pause duration, or grammar. As will be appreciated, in some embodiment, the at least one first verbal input and the at least second verbal input may be a textual input, i.e., in form of a text. In such embodiment, conversion of the at least one first verbal input and the at least one second verbal input to the textual input via the STT conversion may not be required. Further, at step 306-2, a set of input intent maps may be generated using an NLP model. The set of input intent maps may be associated with the at least one second verbal input received from the user. The at least one second verbal input, for example, may include, but is not limited to, a pronunciation of a dialogue rendered to the user as the at least one verbal query in the second language. For example, the dialogue rendered as the at least one verbal query may be “quiero registrarme” in the second language, i.e., Spanish (which means, “I want to register.”) In an embodiment, the user may provide the at least one first verbal input and the at least one second verbal input using a user device, which, for example, may be one of a mobile phone, a computer, a PDA, an assistant, and other similar devices. Moreover, the set of input intent maps may be generated based on a first subset of words extracted from the at least one second verbal input and the plurality of attributes. Based on the first subset of words extracted from the at least one second verbal input, the set of input intent maps may be generated. The generated exemplary set of input intent maps may be represented as:

[“i”,“check-in”,“question”],[“i”,“require”,“to”,“check-in”]

The first subset of words may be processed through at least one of a plurality of intent map transforming algorithms to generate the set of input intent maps. The plurality of intent map transforming algorithms may include a refinement mechanism, a synonym mechanism, a consolidation mechanism, and a reduction mechanism. The set of input intent maps may be one of a set of partial input intent maps and a set of complete input intent maps. The partial input intent maps may be incomplete intent maps and may be progressively generated and updated by iteratively processing the first subset of words through each of the plurality of intent map transforming algorithms in either a sequential manner or a parallel manner while being processed synchronously or asynchronously. In continuation of the above-mentioned example, the set of partial input intent maps may be generated by iteratively processing the first subset of words “i” and “check-in” through each of the refinement mechanism, the synonym mechanism, the consolidation mechanism, and the reduction mechanism. Thus, the generated set of partial input intent maps may, for example, be represented as:

[[‘i’,‘require’,‘to’,‘check-in’],[‘to’,‘check-in’,‘question’],[‘i’,‘check-in’]]

Further, the set of complete input intent maps may refer to fully processed and populated partial input intent maps and may be generated upon completion of the iterative processing of the first subset of words. Alternatively, the first subset of words may be processed by all of the plurality of intent map transforming algorithms in one go to generate the set of complete input intent maps. In an embodiment, the set of input intent maps may correspond to a node network that includes a plurality of nodes. Each of the plurality of nodes is a vector representation of the at least one of the first subset of words.

At step 306-3, each of the set of input intent maps may be matched with each of a plurality of pre-stored sets of intent maps. It may be noted that each of the plurality of pre-stored sets of intent maps may be generated from a single predefined training input. The single predefined training input may include a predefined verbal input. By way of an example, the predefined training input may be “I want to check-in”. Each of the plurality of pre-stored sets of intent maps may further be mapped to a predefined intent, for example, “check-in” and to a predetermined response, for example, “welcome” and the like.

With reference to the above-mentioned example, the word “check-in” from the predefined training input may be used to generate the following alternatives in order to train the NLP model: “come”, “require”, “boarding”, “get”, “checking-in”, and the like. In a similar manner, the word “want” from the predefined training input may be used to generate the following alternatives in order to train the NLP model: “need”, “require”, “wish”, and the like.

Using the above, pre-stored sets of intent maps may be generated for the predefined training input: “I want to check-in.” The pre-stored sets of intent maps may be represented as:

[“i”,“require”,“to”,“check-in”],[“check-in”,“question”],[“i”,“check-in”,“question”],“i”,“to”,“check-in”,“question”],[“i”,“check-in”],[“i”,“question”]

In continuation of the above-mentioned example, each of the set of partial intent maps depicted in paragraph [0052] above may be matched with each of the pre-stored sets of intent maps depicted in paragraph [0056].

At step 306-4, a distance of each of the set of input intent maps relative to each of the plurality of pre-stored sets of intent maps may be determined. The distance may correspond to a level of accuracy of match of each of the set of input intent maps with each of the plurality of pre-stored sets of intent maps. As may be appreciated, higher the level of accuracy of the match, the lower may be the distance and vice-versa. Referring back to the above-mentioned example, the distance of each of the set of input intent maps relative to each of the pre-stored set of intent maps may be determined. The set of input intent maps and the pre-stored set of intent maps are again represented below for convenience:

Set of input intent maps:

[“i”,“check-in”,“question”],[“i”,“require”,“to”,“check-in”]

Pre-stored sets of intent maps:

[“i”,“require”,“to”,“check-in”],[“check-in”,“question”],[“i”,“check-in”,“question”],“i”,“to”,“check-in”,“question”],[“i”,“check-in”],[“i”,“question”]

As may be appreciated, the above mentioned pre-stored sets of input intent maps have been presented for a single input sentence, and the multiple other pre-stored sets of input intent maps may be used for matching. Further, the matching may be based on a least determined distance between the set of input intent maps and the pre-stored set of input intent maps.

Further, at step 306-5, may identify a pre-stored intent map from the plurality of pre-stored sets of intent maps that is closest to the set of input intent maps. Referring back to the above-mentioned example, from the above depicted plurality of pre-stored sets, the pre-stored intent map: [“i” “require”, “to”, “check-in”], may have the least distance to each of the set of input intent maps. As a result, the pre-stored intent map: [“i”, “require”, “to”, “check-in”], may be identified.

Further, at step 306-6, a verbal output reply may be rendered to the user. The initial verbal output reply may correspond to the predetermined response mapped to the pre-stored intent map may be rendered to the user as a reply to the at least one second verbal input. In continuation of the above-mentioned example, the pre-stored intent map: [“i”, “require”, “to”, “check-in”] may be mapped to a predetermined response of “certainly, welcome back.” Thus, in response to the user command of “I want to check-in,” the response “certainly, welcome back” may be rendered to the user. In an embodiment, in the dialogue-based learning, the initial predetermined response may be rendered to the user upon receiving correct pronunciation of the at least one verbal query as the at least one second verbal input. However, upon receiving incorrect pronunciation, a subsequent verbal output reply may be rendered to the user. By way of an example, the subsequent verbal out reply may be correct pronunciation of the at least one verbal query in the second language, correct pronunciation of the at least one verbal query in the first language, or an action (e.g., let's try again) associated with the first verbal query.

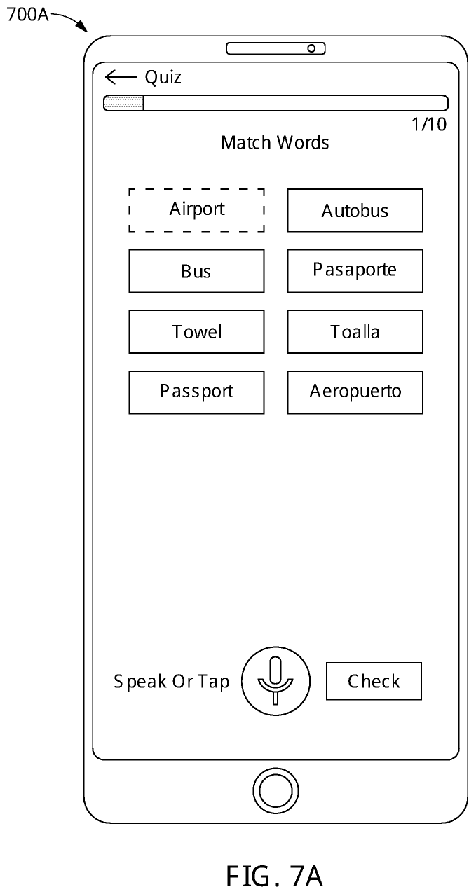

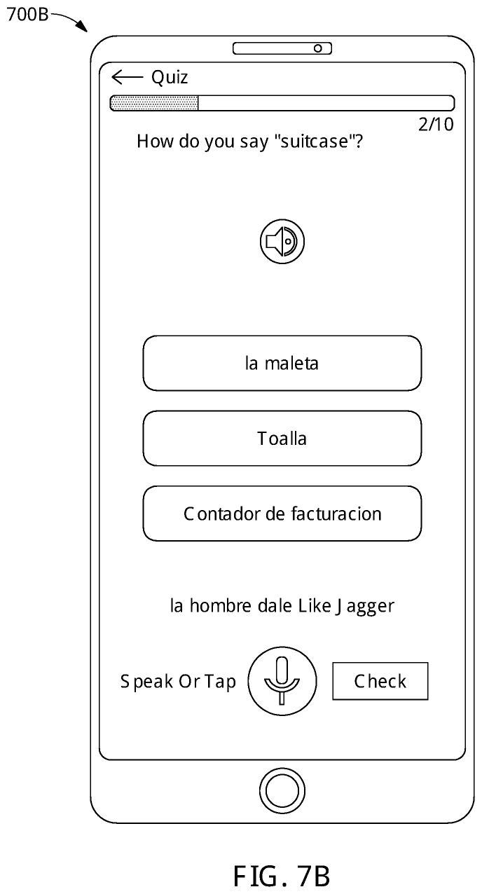

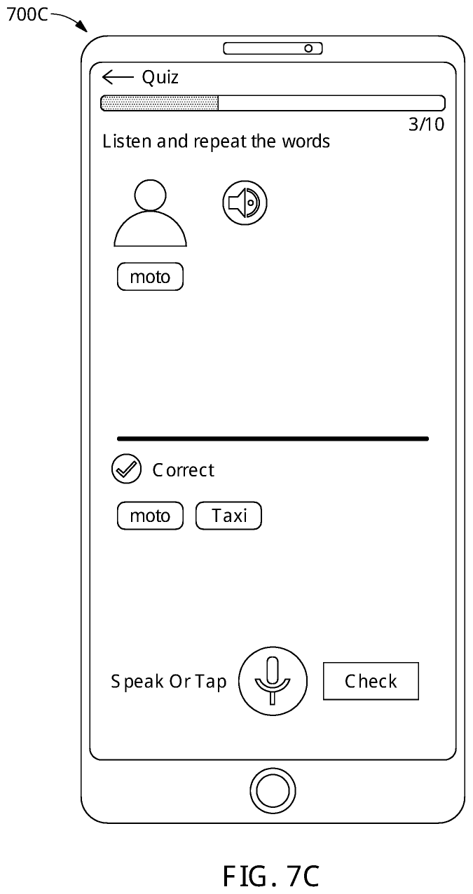

The verbal output reply may indicate at least one incorrect part of speech within the at least one second verbal input. Moreover, each of the initial verbal output reply and the subsequent verbal output reply may be rendered by an Artificial Intelligence (AI) based tutor. In an embodiment, each of the at least one first verbal input, the at least one verbal query, the at least one second verbal input, and the initial verbal output reply may be in form of a phoneme, a sentence, a phrase, a word, or a phoneme in context. In addition to rendering of the verbal output reply, at least one graphical element may be rendered to the user, when each of the plurality of attributes associated with the at least one second verbal input is less than or equal to an associated threshold. In an embodiment, the at least one graphical element may include at least one of performance points, emoticons, ratings, scores, ranks, improvements, or increase in vocabulary or lexical knowledge. As will be appreciated, the threshold may not be fixed and may be varied by the AI module, based on the plurality of attributes and the selected context dimension. Additionally, or alternatively, apart from the AI model, the threshold may be determined based on one or more of other algorithmic models or statistical models. In some embodiments, one or more of the AI model, the algorithmic models, or the statistical models may be specific to the user device on which they have been configured or implemented. This has been further explained in FIG. 7B. It should be noted that each of the step 306-1 to step 306-6 may be iteratively performed while providing context-based language training to the user. Moreover, the NLP model used for by the user for learning different languages may be retrained to update at least one of the plurality of thresholds based on at least one of a user profile or a language proficiency level selected by the user.

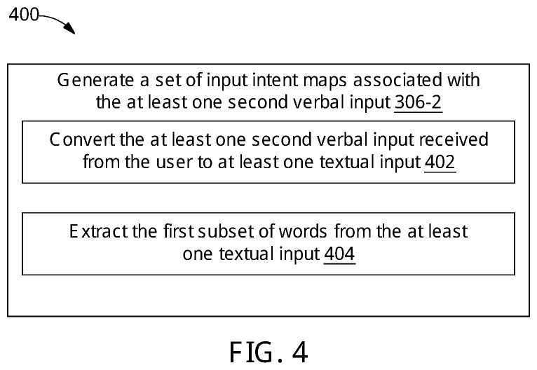

Referring now to FIG. 4, an exemplary process 400 for generating a set of input intent maps is illustrated via a flowchart, in accordance with some embodiments. In order to generate the set of input intent maps, at step 402, the at least one second verbal input received from the user may be converted to at least one textual input using a Speech-to-Text (STT) mechanism. It should be noted that, the at least one textual input may be translated to an intermediate language (for example: English) in which the NLP model may be configured, using translation mechanism. The NLP model configured only using the intermediate language may be used to generate the set of input intent maps in the intermediate language. Further, at step 404, a first subset of words may be extracted from the at least one textual input.

Referring now to FIGS. 5A-5F, various stages of interactive context-based language learning engagement of a user are depicted, in accordance with an embodiment. As depicted via a screenshot 500A, the user may have selected the language Spanish, represented as ‘Español’ that the user in interested in learning. Upon selecting the language ‘Español,’ a set of courses associated with the language may be rendered to the user. As represented via the screenshot, the set of courses may include, general, vocabulary, situation, and business. In addition to the set of courses, number of levels in each of the set of courses may be rendered to the user. In an embodiment, the number of levels may represent total number of practice exercise available for that particular course. By way of an example, in the screenshot 500A, the number of levels in the course “general” may be represented as “21 Level”. Further, number in unshaded box, i.e., ‘1’ may represent number of practice exercise successfully completed by the user. Whereas the number in shaded box, i.e., ‘3’ may represent number of practice exercise incorrectly or partially completed by the user. In a similar manner, for the course ‘vocabulary’, situation, and business, the total number of levels and the number of practice exercises attempted by the user is displayed via the screenshot 500A.

As displayed via the screenshot 500A, total number of levels available for the course is ‘1’. Hence, upon selecting the course ‘situation’, the level available in the course ‘situation’ is displayed via a screenshot 500B. As depicted via the screenshot, the level available in the course ‘situation’ is ‘city break’. As depicted in screenshot 500B, total number of chapters available in the level ‘city break’ are ‘20 Chapters’. Once the user selects the level ‘city break’, a set of chapters available in the level ‘city break’ of the course ‘situation’ may be rendered to the user in a way as depicted via a screenshot 500C. As represented via the screenshot 500C, the set of chapters may include, airport information, airport check-in, lunch onboard, immigration, customs, airport arrivals, hotel check-in, sightseeing, theatre trip, restaurant booking, train trip, pharmacy, and the like.

Further, the user may select a chapter, for example ‘hotel check-in’, from the rendered set of chapters. Upon selecting the chapter ‘hotel check-in’, a set of practice area associated with the chapter ‘hotel check-in’ may be rendered to the user. This is depicted via a screenshot 500D. The user may select any practice area from the rendered set of practice area based on his requirement. A screenshot 500E represents total number of quizzes attempted by the user for each practice area. Further, a number in unshaded box may represent correct number of quizzes. Whereas a number in shaded box may represent incorrect number of quizzes. For example, in the screenshot 500E, number of quizzes correctly completed for the practice area ‘drill’ is represented as ‘4’ in the unshaded box. Similarly, for the practice area ‘exercise’, number of correct quizzes is ‘1’, while the number of incorrect quizzes is ‘4’.

Further, referring back to FIG. 5D, suppose the user may have selected the practice area ‘dialogue’. Upon selecting the practice area ‘dialogue’, a first verbal query may be rendered to the user. The first verbal query rendered to the user may be in the second language, i.e., Spanish. The user may need to pronounce the first verbal query correctly. The pronunciation of the first verbal query may be a second verbal input provided by the user. Based on processing of the second verbal input, a verbal output reply may be rendered to the user. With reference to FIG. 3, in order to process the second verbal input to provide the verbal output reply, step 306-1 to step 306-5 may be executed.

It should be noted that, the verbal output reply may be rendered to the user upon identifying at least one incorrect part of speech within the second verbal input. By way of example, when the user provides the correct pronunciation of the second verbal input, the predetermined response may be rendered to the user. The user may need to correctly pronounce the predetermined response, that may be considered as another second verbal input. This another second verbal input may be processed to render subsequent predetermined response. The processes of rendering the predetermined response may continue, until the user provides the correct pronunciation of the predetermined responses rendered to the user. However, when the user provides incorrect pronunciation of the second verbal query or any of the predetermined response rendered to the user, the verbal output reply may be rendered to the user in the first language. The above discussed process of the ‘dialogue practice area’ has been depicted via a screenshot 500F.

Referring now to FIG. 6, an exemplary representation 600 of confidence scores computed for multiple speech to text conversions of a verbal input received from a user is depicted, in accordance with an exemplary embodiment. With reference to FIG. 5F, in “the dialogue practice area” represented via the screenshot 500F, upon receiving the verbal input, for example, “Cuál es mi número de habitación” (i.e., “what is my room number”) for the verbal query rendered to the user in the second language (i.e., Spanish), a confidence score may be calculated. The confidence score may be calculated based on pronunciation of the verbal input received from the user. The confidence score calculated for the verbal query “Cuál es mi número de habitación” may be depicted as represented via a table 602. It should be noted that, the confidence score for the verbal input received from the user may be calculated by converting the received verbal input to the textual input in the intermedia language (i.e., English) using translation mechanism. In an embodiment, the confidence score may correspond to an accuracy or confidence of the conversion of the verbal input into the associated textual input and is based on a predetermined STT training set. As may be appreciated, one or more of textual inputs having a higher confidence score may replace textual inputs with lesser confidence scores. Basis this replacement, the set of input intent maps may be generated for the textual inputs having a higher confidence score and may be compared with each of the plurality of pre-stored sets of intent maps.

By way of an example, as depicted via the present FIG. 6, a unique confidence score may be associated with each of the textual inputs and may be represented as, for example, {“what is my roll number”, “confidence”: “: 0.9299548864364624}, {“what is my room number”, “confidence”: 0.8493034362792969}, {“what is my wrong number”, “confidence”: 0.6988619565963745}, {“what is my roman number”, “confidence”: 0.6491488218307495}, {“it is my room number”, “confidence”: 0.7528527975082397}, {“W is my room number”, “confidence”: 0.7528527975082397}.

Referring now to FIGS. 7A-7C, an exemplary representation of quizzes attempted by a user is depicted via screenshots, in accordance with an embodiment. With reference to FIGS. 5A-5F, when the user interested in learning the ‘Spanish’ language, selects the practice area ‘drill’ represented via the screenshot 500D, a quiz may be rendered to the user. By way of an example, a first question rendered to the user may be ‘match words’ as depicted via a screenshot 700A. In this quiz, the user may need to match words displayed in the first language (i.e., English) with words displayed in the second language (i.e., Spanish). Further, as displayed via the screenshot 700A, the user can check his answer by using a checkbox depicted as ‘check’ on right bottom corner of the screenshot 700A. Similarly, a second question of the quiz rendered to the user is depicted via a screenshot 700B. As depicted via the screenshot 700B, the second question may be ‘how do we speak word suitcase’ along with which a set of options in the second language may be provided to the user. The user may need to provide correct pronunciation of the word suitcase in the Spanish language. The user may check his answer using the checkbox depicted via the screenshot 700B.

After receiving response (the answer) for the second question, third question may be rendered to the user as depicted via the screenshot 700C. This process of rendering questions to the user, upon receiving the corresponding answers may continue unit the quiz gets completed. In an embodiment, upon clicking on checkbox, at least one graphical element may be rendered to the user based on the answer provided for the correspond question. The graphical element may include at least one of performance points, emoticons, ratings, scores, ranks, improvements, or increase in vocabulary or lexical knowledge. In an embodiment, the graphical element may be rendered based on the threshold associated with each of the plurality of attributes of the answer. The plurality of attributes may include at least one of utterance speed, accentuation, voice pitch, vocabulary, pause duration, or grammar. By way of an example, when the user provides correct pronunciation of the word suitcase in Spanish language as the answer and a threshold determined for each of the plurality of attributes of the answer is greater than the associated threshold, then a happy face emoticon may be rendered to the user. By way of another example, when the user provides wrong pronunciation of the word suitcase in Spanish language with lower voice pitch as the answer and a threshold determined for each of the plurality of attributes of the answer is less than or equal to the associated threshold, then a sad face emoticon may be rendered to the user. As will be appreciated, the threshold may not be fixed and may be varied by the AI module, based on the plurality of attributes and the selected context dimension. Additionally, or alternatively, apart from the AI model, the threshold may be determined based on one or more of other algorithmic models or statistical models. In some embodiments, one or more of the AI model, the algorithmic models, or the statistical models may be specific to the user device on which they have been configured or implemented.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As will be appreciated by those skilled in the art, the techniques described in the various embodiments discussed above are not routine, or conventional, or well understood in the art. The techniques discussed above may automatically render at least one verbal query in the second language based on the selected context dimension. The technique may iteratively receive at least one second verbal input from the user in the second language in response to the rendered at least one verbal query. The at least one second verbal input received may include a plurality of attributes. The technique may iteratively generate a set of input intent maps associated with the at least one second verbal input based on a first subset of words extracted from the at least one second verbal input and the plurality of attributes. Generating the set of input intent maps may include processing the first subset of words through at least one of a plurality of intent map transforming algorithms. The set of input intent maps may be one of a set of partial input intent maps and a set of complete input intent maps. The technique may iteratively match each of the set of input intent maps with each of a plurality of pre-stored sets of intent maps. Each of the plurality of pre-stored sets of intent maps may be generated from a single predefined training input and is mapped to a predefined intent and a predetermined response. The single predefined training input may include a predefined verbal input. The technique may determine a distance of each of the set of input intent maps relative to each of the plurality of pre-stored sets of intent maps. The technique may identify a pre-stored intent map from the plurality of pre-stored sets of intent maps closest to the set of input intent maps. The technique may render a verbal output reply to the user. The initial verbal output reply may correspond to the predetermined response mapped to the pre-stored sets of intent maps.

Thus, the disclosed method and system tries to overcome the problem of understanding intent, purpose, requests and sentence parts from verbal inputs received from a user, using NLP. The disclosed method and system provide efficient context-based language training to the user by understanding intents from the verbal inputs provided by the user. The method and system may include constructing an intent map from the verbal inputs using a single predefined training input. The disclosed system and method may provide a set of intent maps for known intents that may be pre-calculated along with derived intents. The derived intents may be obtained using intent map transforming algorithms (for example, an elastic and iterative process) that may include at least one of a refinement mechanism, a consolidation mechanism, a synonym mechanism, and a reduction mechanism. The derived intents may be indexed and cached for matching an intent determined from the verbal input and may thus improve performance of matching process. The disclosed system and method may provide a better understanding of the intent from the verbal input through machine translation.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for providing context-based language training. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for providing context-based language training, the method comprising:
automatically rendering at least one verbal query in a second language based on a selected context dimension; and
iteratively performing:
receiving at least one second verbal input from the user in the second language in response to the rendered at least one verbal query, wherein the received at least one second verbal input comprises a plurality of attributes;
generating, by Natural Language Processing (NLP) model, a set of input intent maps associated with the at least one second verbal input based on a first subset of words extracted from the at least one second verbal input and the plurality of attributes, wherein generating the set of input intent maps comprises processing the first subset of words through at least one of a plurality of intent map transforming algorithms, and wherein the set of input intent maps is one of a set of partial input intent maps and a set of complete input intent maps;
matching each of the set of input intent maps with each of a plurality of pre-stored sets of intent maps, wherein each of the plurality of pre-stored sets of intent maps is generated from a single predefined training input and is mapped to a predefined intent and a predetermined response, and wherein the single predefined training input comprises a predefined verbal input;
determining a distance of each of the set of input intent maps relative to each of the plurality of pre-stored sets of intent maps;
identifying a pre-stored intent map from the plurality of pre-stored sets of intent maps closest to the set of input intent maps; and
rendering to the user, by the NLP model, a verbal output reply, wherein the initial verbal output reply corresponds to the predetermined response mapped to the pre-stored sets of intent maps.

2. The method of claim 1, further comprising:
receiving at least one first verbal input from a user in a first language, wherein the at least one first verbal input is associated with the selected context dimension selected from a plurality of context dimensions created for learning the second language, wherein the first language and the second language are dissimilar.

3. The method of claim 1, wherein the verbal output reply indicates at least one incorrect part of speech within the at least one second verbal input.

4. The method of claim 1, wherein generating the set of input intent maps:
converting the at least one second verbal input received from the user to at least one textual input using a Speech-to-Text (STT) mechanism; and
extracting the first subset of words from the at least one textual input.

5. The method of claim 1, wherein the plurality of attributes comprises at least one of utterance speed, accentuation, voice pitch, vocabulary, pause duration, or grammar.

6. The method of claim 1, wherein each of the at least one first verbal input, the at least one verbal query, the at least one second verbal input, and the initial verbal output reply is in form of a sentence, a phrase, a word, or a phoneme in context.

7. The method of claim 1, further comprising rendering at least one graphical element to the user, when each of the plurality of attributes is less than or equal to the associated threshold.

8. The method of claim 7, wherein the at least one graphical element comprises at least one of performance points, emoticons, ratings, scores, ranks, improvements, or increase in vocabulary or lexical knowledge.

9. The method of claim 1, further comprising training the NLP model to update at least one of the plurality of thresholds based on at least one of a user profile or a language proficiency level selected by the user.

10. The method of claim 1, wherein each of the initial verbal output reply and the subsequent verbal output reply is rendered by an Artificial Intelligence (AI) based tutor.

11. A system for providing context-based language training, the system comprising:
a processor; and
a memory communicatively coupled to the processor, wherein the memory stores processor-executable instructions, which, on execution, causes the processor to:
automatically render at least one verbal query in a second language based on a selected context dimension; and
iteratively perform:
receiving at least one second verbal input from the user in the second language in response to the rendered at least one verbal query, wherein the received at least one second verbal input comprises a plurality of attributes;
generating, by Natural Language Processing (NLP) model, a set of input intent maps associated with the at least one second verbal input based on a first subset of words extracted from the at least one second verbal input and the plurality of attributes, wherein generating the set of input intent maps comprises processing the first subset of words through at least one of a plurality of intent map transforming algorithms, and wherein the set of input intent maps is one of a set of partial input intent maps and a set of complete input intent maps;
matching each of the set of input intent maps with each of a plurality of pre-stored sets of intent maps, wherein each of the plurality of pre-stored sets of intent maps is generated from a single predefined training input and is mapped to a predefined intent and a predetermined response, and
wherein the single predefined training input comprises a predefined verbal input;
determining a distance of each of the set of input intent maps relative to each of the plurality of pre-stored sets of intent maps;
identifying a pre-stored intent map from the plurality of pre-stored sets of intent maps closest to the set of input intent maps; and
rendering to the user, by the NLP model, a verbal output reply, wherein the initial verbal output reply corresponds to the predetermined response mapped to the pre-stored sets of intent maps.

12. The system of claim 11, wherein the processor-executable instructions further cause the processor to receive at least one first verbal input from a user in a first language, wherein the at least one first verbal input is associated with the selected context dimension selected from a plurality of context dimensions created for learning the second language, wherein the first language and the second language are dissimilar.

13. The system of claim 11, wherein the verbal output reply indicates at least one incorrect part of speech within the at least one second verbal input.

14. The system of claim 11, wherein, to generate the set of input intent maps, the processor-executable instructions further cause the processor to:
convert the at least one second verbal input received from the user to at least one textual input using a Speech-to-Text (STT) mechanism; and
extract the first subset of words from the at least one textual input.

15. The system of claim 11, wherein the plurality of attributes comprises at least one of utterance speed, accentuation, voice pitch, vocabulary, pause duration, or grammar.

16. The system of claim 11, wherein each of the at least one first verbal input, the at least one verbal query, the at least one second verbal input, and the initial verbal output reply is in form of a phoneme, a sentence, a phrase, a word, or a phoneme in context.

17. The system of claim 11, wherein the processor-executable instructions further cause the processor to:
render at least one graphical element to the user, when each of the plurality of attributes is less than or equal to the associated threshold.

18. The system of claim 17, wherein the at least one graphical element comprises at least one of performance points, emoticons, ratings, scores, ranks, improvements, or increase in vocabulary or lexical knowledge.

19. The system of claim 11, wherein the processor-executable instructions further cause the processor to:
train the NLP model to update at least one of the plurality of thresholds based on at least one of a user profile or a language proficiency level selected by the user.

20. A non-transitory computer-readable medium storing computer-executable instructions for providing language based adaptive feedback to users, the computer-executable instructions configured for:
automatically rendering at least one verbal query in a second language based on a selected context dimension;
iteratively performing:
receiving at least one second verbal input from the user in the second language in response to the rendered at least one verbal query, wherein the received at least one second verbal input comprises a plurality of attributes;
generating, by Natural Language Processing (NLP) model, a set of input intent maps associated with the at least one second verbal input based on a first subset of words extracted from the at least one second verbal input and the plurality of attributes, wherein generating the set of input intent maps comprises processing the first subset of words through at least one of a plurality of intent map transforming algorithms, and wherein the set of input intent maps is one of a set of partial input intent maps and a set of complete input intent maps;
matching each of the set of input intent maps with each of a plurality of pre-stored sets of intent maps, wherein each of the plurality of pre-stored sets of intent maps is generated from a single predefined training input and is mapped to a predefined intent and a predetermined response, and wherein the single predefined training input comprises a predefined verbal input;
determining a distance of each of the set of input intent maps relative to each of the plurality of pre-stored sets of intent maps;
identifying a pre-stored intent map from the plurality of pre-stored sets of intent maps closest to the set of input intent maps; and
rendering to the user, by the NLP model, a verbal output reply, wherein the initial verbal output reply corresponds to the predetermined response mapped to the pre-stored sets of intent maps.
